(19) United States
(12) Patent Application Publication
(10) Pub. No.: US 2003/0019201 A1
(43) Pub. Date: Jan. 30, 2003

(54) Floating deck material collection system

(75) Inventor: Jimmy N. Eavenson SR., Aurora, OH (US)

Correspondence Address: Heather M. Barnes, Esq., Fourteenth Floor, One Cascade Plaza, Akron, OH, 44308-1381, US

(73) Assignee: Commercial Turf Products, Ltd., Streetsboro, OH

(21) Appl. No.: 09/916,632

(22) Filed: Jul. 27, 2001

(51) Int. Cl. A01D 34/71

(52) U.S. Cl. 56/202; 56/194; 56/320.2

(57) ABSTRACT

A lawn care device comprises a main frame having at least two wheels attached thereto for engaging an associated underlying surface. A mower deck is operatively connected to the main frame. A power means is operatively mounted to the main frame. A non-mower deck implement operatively connects to the main frame. The non-mower deck implement is adapted to follow the contour of the underlying surface. More specifically, the non-mower deck implement is a ground following implement or a floating implement.

### I. BACKGROUND OF THE INVENTION

A. Field of the Invention

This invention relates to the art of lawn mowers and more specifically to a material collection system, especially for use with a floating deck.

B. Description of the Related Art

In many typical riding mowers, the mower deck is configured as either a ground-following deck or a floating deck. A ground-following deck typically rides on either two or four caster wheels and follows the contours of the ground. A floating deck is hung between the front and rear wheels and beneath the chassis by chains, links or other devices. The floating deck is adapted to rise vertically when skids, wheels, rollers and the like attached to the underside of the deck make contact with the underlying surface. Generally, the intent for such deck suspension system is to avoid continuing contact with the underlying surface.

The distance of the mower deck from the underlying surface is determined by the elevation of the chassis. When the mower crosses a rise in the underlying surface, which is relatively severe, that is, short in horizontal length compared to the wheel base of the mower and great in height compared to the pre-set elevation of the mower deck, the deck frequently makes contact with the earth surface. When this occurs, it is intended that the deck rises or “floats” upwardly, so the rotary blades do not impact the underlying surface.

Such designs suit their intended purpose; however, these designs fail to take into account the attachment position and design of other implements mounted to the lawn care vehicle. Sometimes, the implement, such as a grass collection bag, is directly attached to the mower deck. As such, operation of floating or ground-followings mower decks is often inhibited by the weight of the attached implement, especially as the collection bag fills with debris. This can affect the lawn care device's overall performance. For example, if a floating deck cannot properly lift during operation due to the attached implement, the mower deck and/or the rotating blade may impact the underlying surface. This could damage both the rotating blade and the mower deck.

The following patents disclose several mowers related to the art of vegetation mowing or grass cutting.

U.S. Pat. No. 4,637,202 to Lamusga discloses a lightweight and inexpensive means for supporting a plurality of bags for collecting grass clippings. The invention further discloses a means for depositing clippings into two reusable bags, which can easily be removed from the mower without tools, and without manipulating a cumbersome framework. The invention further discloses a common framework that can be used to support a plurality of small grass bags, or, alternatively, one large leaf bag for collecting leaves or the like. The invention of this patent does not indicate nor show structure that would indicate uninhibited operation of the mower deck.

U.S. Pat. No. 5,845,473 to Hopkins et al. discloses a bagger with a pair of doors at its opening for use with a walk-behind mower. The patent further discloses a rectangular metal framework with one door being swingably attached thereto, which would enable the bag to receive clippings during the mowing process and contain them in the bag when it is carried from the mower to a discharge area. The invention of this patent does not disclose or indicate that the features thereof provide uninhibited operation of the mower deck; but, rather, pertain to the ease and containment of the clippings within the material collection bag after it is removed from the mower.

U.S. Pat. No. 4,843,805 to Satoh discloses a lawn mower with a door, which closes the opening at the rear end of a mowed grass discharge duct, when a mowed grass catcher bag is not mounted on the rear of the duct. The patent further discloses a door for closing the discharge port has been provided to prevent the danger that the mower may be operated without the bag and that gravel or other debris are discharged from the exposed discharge port. This patent does not disclose or indicate that any means are provided to facilitate uninhibited operation of the mower deck for use in conjunction with a discharged clipping bag.

Therefore, a need in the art exists for an apparatus that provides uninhibited operation of the mower deck for use in conjunction with a material collection system.

### II. SUMMARY OF THE INVENTION

A vehicle comprises a main frame having at least two wheels attached thereto for engaging an associated underlying surface. A mower deck is operatively connected to the main frame. A non-mower deck implement operatively connects to the main frame. The non-mower deck implement is adapted to follow the contour of the underlying surface. A power means is operatively mounted to the main frame. Accordingly, it is an object of the present invention to provide a vehicle having a non-mower deck implement that is ground following or “floating.”

Another object of the present invention is to provide a vehicle wherein the non-mower deck implement is a material collection system.

Further, another object of the present invention is to provide a vehicle wherein the material collection system comprises a frame assembly, where the frame assembly attaches to the main frame of the vehicle; and, a collection bag operatively connected to the frame assembly.

Yet another object of the present invention is to provide a vehicle, wherein the frame assembly comprises a panel member and a frame member, wherein the frame member interconnects the collection bag to the panel member, and the panel member interconnects the frame member to the main frame.

Still yet, another object of the present invention is to provide a vehicle, wherein the non-mower deck implement further comprises at least one castor wheel assembly attached to the frame assembly.

Another object of the present invention is to provide a vehicle, wherein the material collection system operatively connects to the mower deck through a flexible connection chute.

Further, another object of the present invention is to provide a vehicle that is a lawn care vehicle, and more specifically, a walk behind mower.

Still, another object of the present invention is to provide a vehicle wherein the chute is adapted to provide a passageway for material to pass from beneath the mower deck and into the collection bag.

Yet, another object of the present invention is to provide a vehicle, wherein the material collection system further comprises an adapter mechanism attached to the panel and to the chute, where the adapter mechanism is adapted to provide a substantially continuous passageway from the chute to the collection bag.

It is yet another object of the present invention to provide a vehicle, wherein the mower deck is a ground following mower deck or a floating mower deck.

Another object of the present invention to provide a method for utilizing a material collection system, the method comprising the steps of:

providing a walk behind mower having a main frame, a plurality of wheels operatively connected to the frame, a mower deck operatively connected to the main frame, and an engine operatively mounted to the main frame;

providing a material collection system operatively connected to the main frame, the material collection system having a plurality of castor wheel assemblies attached thereto;

mobilizing the walk behind mower over the underlying surface;

engaging the castor wheel assemblies with the underlying surface;

maintaining the plurality of castor wheel assemblies engaged with the underlying surface.

Yet another object of the present invention is to provide a method for utilizing a material collection system, wherein the mower deck comprises a flexible chute, the flexible chute attaching the mower deck and to the material collection system. The method further comprises the step of moving the flexible chute as the walk behind mower is mobilized over the underlying surface in order to maintain the plurality of castor wheel assemblies engaged with the underlying surface.

Still other benefits and advantages of the invention will become apparent to those skilled in the art to which it pertains upon a reading and understanding of the following detailed specification.

Another object of the present invention is to provide a material collection system, which does not inhibit floating mower deck operation.

### III. BRIEF DESCRIPTION OF DRAWINGS

The invention may take physical form in certain parts and arrangement of parts, a preferred embodiment of which will be described in detail in this specification and illustrated in the accompanying drawings which form a part hereof and herein:

FIG. 1 is a perspective view of a walk behind mower;

FIG. 2 is a perspective view of the present invention; and,

FIG. 3 is an exploded perspective view of the present invention.

### IV. DETAILED DESCRIPTION OF THE INVENTION

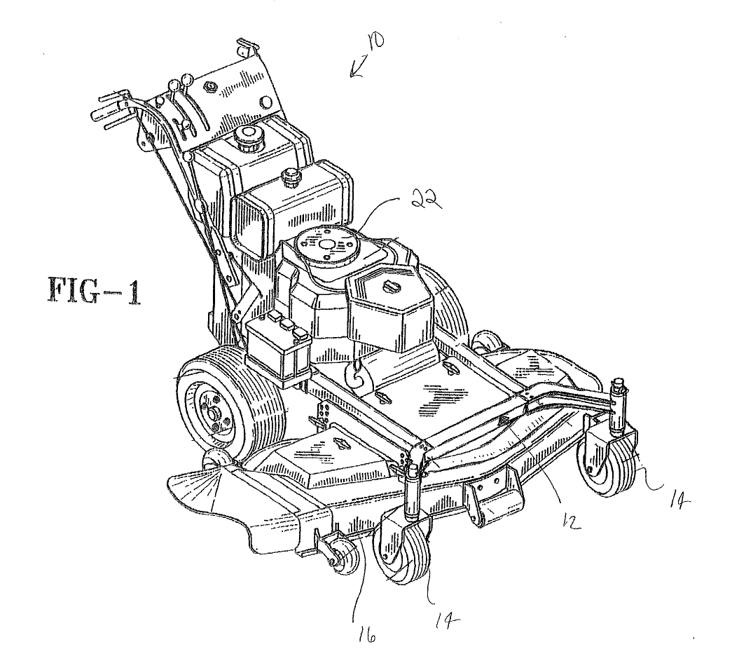

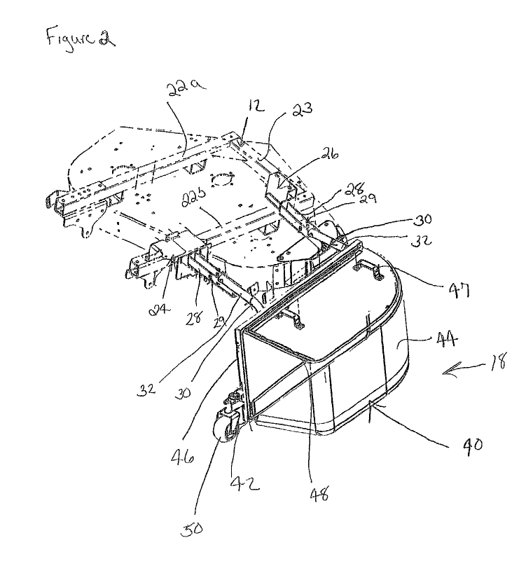

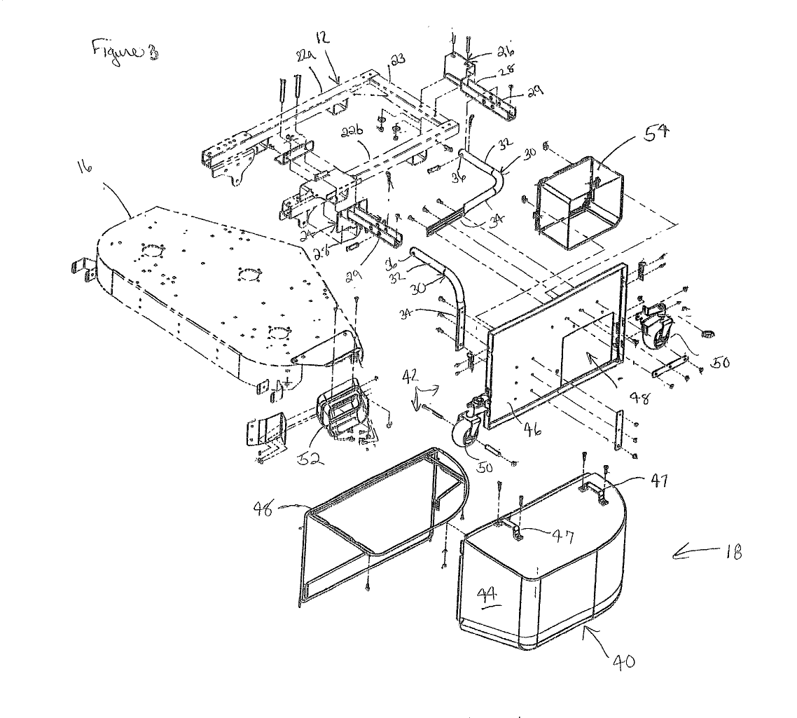

Referring now to the drawings wherein the showings are for purposes of illustrating a preferred embodiment of the invention only and not for purposes of limiting the same, FIGS. 1-3 illustrate the present invention. A vehicle, such as, but not limited to, a lawn care device 10, is shown in FIG. 1, and more specifically, a walk behind mower. The lawn care device 10 comprises a main frame 12 having at least two wheels 14 attached thereto for engaging an associated underlying surface. A mower deck 16 operatively connects to the main frame 12, as shown in FIGS. 2 and 3. A non-mower deck implement 18 operatively connects to the main frame 12. Power means 22, such as an engine, is operatively mounted to the main frame 12.

Viewing FIGS. 2 and 3, the main frame 12 comprises two end frame members 22a, 22b, which are interconnected by an intermediate frame member 23. First and second support brackets 24, 26 attach to the main frame 12. The first support bracket 24 attaches to frame member 22b, and the second support bracket 26 attaches to the intermediate frame member 23. The support brackets 24, 26 provide for selective attachment of the non-mower deck implement 18. As shown in FIG. 3, each support bracket 24, 26 has an extended support member 28. The extended support members 28 have a plurality of apertures 29 defined therein for selective attachment of attachment arms 30. Each attachment arm 30 comprises a first end 32 and a second end 34. The first end 32 has a hole 36 defined therein. The second end 34 of each attachment arm 30 is adapted to fasten to the non-mower deck implement 18 described in further detail below. During assembly, the holes 36 of the extensions arms 30 are aligned with the desired apertures 29 of the support members 28. A pin or other similar fastener is passed through the hole 36 and aperture 29 to secure the attachment arms 30 to the respective support brackets 24, 26. Attachment of the frame components may be achieved through the use of any fastening means well known in the art, provided it is chosen in accordance with sound engineering judgment, including without limitation, pins, screws, bolts, rivets or other similar fasteners.

As shown in FIGS. 1-3, the mower deck 16 may be a floating deck. More specifically, it is suspended by adjustable length chains or other hangers (not shown), which limit the downward motion of the deck, yet allow the deck to move vertically, such as when the wheels or other parts on the underside of the deck encounter a rise in the earth surface during mowing. Alternatively, the mower deck may be ground following such that the mower deck 16 rides on either two or four caster wheels and follows the contours of the ground. For the purposes of this patent application, the terms “floating deck” and “ground following deck” will be used interchangeably. Further, “floating” and “ground following” shall be used interchangeably and shall describe any apparatus that is adapted to follow the contours of an underlying surface regardless of the mechanism utilized to achieve those means.

Turning to FIGS. 2 and 3, the non-mower deck implement 18 may be floating or ground following, such that it is adapted to follow the contour of the underlying surface. As shown in FIGS. 2 and 3, the non-mower deck implement 18 is a material collection system 40. Although the embodiment described herein is a material collection system 40, such as a bagger, any implement besides a mower deck that is floating or ground following is contemplated to be within the scope of the present invention. Turning to FIGS. 1 and 2, the material collection system 40 comprises a frame assembly 42 and a collection bag 44 operatively connected thereto. The frame assembly 42 is attached to the main frame 12 of the lawn care device by way of the attachment arms 30 as previously described. The frame assembly 42 also comprises a panel member 46 and a frame member 48, wherein the frame member 48 interconnects the collection bag 44 to the panel member 46, and the panel member 46 interconnects the frame member 48 to the main frame 12. The collection bag 44 may also have handles 47 in order to easily manipulate the collection bag 44 during attachment and detachment.

Next, the non-mower deck implement 18 further comprises at least one caster wheel assembly 50 attached to the frame assembly. As shown in FIG. 2, two caster wheel assemblies 50 are attached to the panel member 46. The castor wheel assemblies 50 may be attached to any part of the non-mower deck implement 18 chosen with sound engineering judgment. Further, any number of castor wheel assemblies 50 may be utilized with the non-mower deck implement 18, provided the implement 18 may “float” as it travels along an underlying surface. Castor wheel assemblies 50 are well known in the art, and will not be further described.

The material collection system 40 may also comprise a flexible connection chute 52, best seen in FIG. 2, which is connected to the mower deck 16 and to the material collection system 40. As the material collection system 40 rides along the underlying surface, the caster wheel assemblies 50 allow for the collection bag 44 to adapt to changing terrain elevation and prevent the collection bag 44 from unnecessary impact with the underlying surface. Further, the flexible chute 52 helps maintain the material collection system's 40 operational position. As shown in FIG. 2, the flexible chute 52 allows the collection bag 44 to move upward, downward and side to side relative to the mower deck without compromising the passage of material from beneath the mower deck 16 and into the collection bag 44.

An opening 48 is defined in the panel member 46 for material, such as grass clippings and other debris, to pass therethrough. The flexible chute 52 provides a passageway for material to pass from beneath the mower deck 16, through the opening 48 in the panel member 46, and into the collection bag 44. An adaptor mechanism 54 attaches to the panel member 46 and to the chute 52. The adaptor mechanism 54 provides a smooth transition for the material to follow since the openings of the chute 52 and the panel member 46 may be different.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A lawn care vehicle, comprising:
a main frame having at least two wheels attached thereto for engaging an associated underlying surface;
a mower deck operatively connected to said main frame;
a non-mower deck implement operatively connected to said main frame, said non-mower deck implement adapted to follow the contour of the underlying surface; and,
power means operatively mounted to said main frame.

2. The lawn care vehicle of claim 1, wherein said non-mower deck implement is a material collection system.

3. The lawn care vehicle of claim 2, wherein said material collection system comprises:
a frame assembly, said frame assembly attaching to said main frame of said vehicle; and,
a collection bag operatively connected to said frame assembly.

4. The lawn care vehicle of claim 3, wherein said frame assembly comprises:
a panel member; and,
a frame member, wherein said frame member interconnects said collection bag to said panel member, and said panel member interconnects said frame member to said main frame.

5. The lawn care vehicle of claim 3, wherein said non-mower deck implement further comprises at least one castor wheel assembly attached to said frame assembly.

6. The lawn care vehicle of claim 2, wherein said material collection system operatively connects to said mower deck through a connection chute.

7. The lawn care vehicle of claim 5, wherein said connection chute is flexible.

8. The lawn care vehicle of claim 1, wherein said lawn care vehicle is a walk behind mower.

9. A lawn care vehicle, comprising:
a main frame;
a plurality of wheels operatively connected to said frame;
a mower deck operatively connected to said frame;
a non-mower deck implement operatively connected to said frame, said non-mower deck implement adapted to follow the contour of an associated underlying surface; and,
an engine operatively mounted to said frame.

10. The lawn care vehicle of claim 9, wherein said non-mower deck implement is a material collection system.

11. The lawn care vehicle of claim 10, wherein said material collection system comprises:
a panel member;
a frame member;
a collection bag, said frame member interconnecting said collection bag to said panel member, and said panel member interconnecting said frame member to said main frame.

12. The lawn care vehicle of claim 11, wherein said panel member further comprises an opening defined therein for material to pass therethrough.

13. The lawn care vehicle of claim 12, further comprising a chute, said chute adapted to provide a passageway for material to pass from beneath said mower deck and into said collection bag.

14. The lawn care vehicle of claim 13, wherein said chute is flexible.

15. The lawn care vehicle of claim 13, wherein said material collection system further comprises an adapter mechanism attached to said panel and to said chute, said adapter mechanism adapted to provide a substantially continuous passageway from said chute to said collection bag.

16. The lawn care vehicle of claim 9, wherein said non-mower deck implement comprises at least one castor wheel assembly attached thereto.

17. The lawn care vehicle of claim 9, wherein said mower deck further comprises at least one castor wheel assembly attached thereto.

18. A method for utilizing a material collection system, the method comprising the steps of:
providing a walk behind mower having a main frame, a plurality of wheels operatively connected to said frame, a mower deck operatively connected to said main frame, and an engine operatively mounted to said main frame;
providing a material collection system operatively connected to said main frame, said material collection system having a plurality of castor wheel assemblies attached thereto;
mobilizing said walk behind mower over the underlying surface;
engaging said castor wheel assemblies with the underlying surface;
maintaining said plurality of castor wheel assemblies engaged with said underlying surface.

19. The method of claim 18, wherein said mower deck comprises a flexible chute, said flexible chute attaching said mower deck and to said material collection system.

20. The method of claim 19, further comprising the step of:
moving said flexible chute as said walk behind mower is mobilized over the underlying surface in order to maintain said plurality of castor wheel assemblies engaged with said underlying surface.

21. A vehicle, comprising:
a frame; and,
a non-mower deck implement operatively connected to said frame, said non-mower deck implement adapted to follow the contour of an associated underlying surface.

22. A walk behind mower, comprising:
a main frame;
a plurality of wheels operatively connected to said main frame;
a mower deck operatively connected to said main frame;
a flexible chute attached to said mower deck;
an engine operatively mounted to said main frame; and,
a material collection system operatively connected to said main frame, said material collection system adapted to follow the contour of an associated underlying surface, said material collection system comprising:
a panel member having an opening defined therein for material to pass therethrough;
two castor wheel assemblies for contacting the underlying surface, said two castor wheel assemblies being attached to said panel member;
a frame member;
a collection bag; and,
an adapter mechanism attached to said panel and to said chute, said frame member interconnecting said collection bag to said panel member, said panel member interconnecting said frame member to said main frame, and said adapter mechanism adapted to provide a substantially continuous passageway from beneath said mower deck, through said flexible chute, and into said collection bag.
